(19) United States
(12) Patent Application Publication
(10) Pub. No.: US 2009/0242076 A1
(43) Pub. Date: Oct. 1, 2009

(54) APPARATUS FOR THE AUTOMATIC REMOVAL OF SAMPLES FROM A CONTINUOUS FLOW

(75) Inventors: Jean-Louis Janeau, Scottsville (ZA); Norbert Silvera, Bangkok (TH); Jean-Pierre Bricquet, Castelnaule-Lez (FR)

Correspondence Address: YOUNG & THOMPSON, 209 Madison Street, Suite 500, ALEXANDRIA, VA, 22314, US

(73) Assignee: Institut De Recherche Pour Le Development, Paris (FR)

(21) Appl. No.: 12/278,399

(22) PCT Filed: Jan. 18, 2007
(86) PCT No.: PCT/FR07/00092

§ 371 Date: Jan. 2, 2009

(30) Foreign Application Priority Data
Feb. 8, 2006 (FR) 0601104

(51) Int. Cl. B65B 1/04; F16H 1/16

(52) U.S. Cl. 141/324; 74/425

(57) ABSTRACT

Apparatus for the automatic removal of samples of water from a continuous flow, having a frame (1) comprising a horizontal platform (4) supporting a plurality of containers (32) each designed to receive, via its open upper filling orifice (33), a water sample, and a driving ring gear mounted on a water supply pipe connected to a suction pump and joined to a dispensing arm (27) that delivers to each container in turn a sample following the rotation of this arm, the appliance being characterized in that the supporting plate has a distribution disc (23) parallel to the plate and having an even number of dispensing passages (29) numbering twice as many as the containers, half of these passages each being arranged in front of an open orifice of one of these containers and separated from each other by an analogous intermediate passage of evacuation.

The present invention relates to an apparatus for the automatic taking of samples of water, in particular for providing the collection of such samples from a continuous flow, the characteristics of which vary over time, in particular from a river or the like, in order to make it possible to measure various parameters on these samples, by taking into account certain point-in-time data specific to this continuous flow, such as its flow rate and its velocity.

More particularly, the invention relates to an apparatus capable of taking a succession of samples from the continuous flow, sequenced with respect to time and/or the depth of water in the latter, in order to measure, in particular on each sample corresponding to such sample-taking, the quantity of particles in suspension and its turbidity by volume unit, with respect to the velocity and flow rate of the continuous flow, also to the variation in level of the latter and the total quantity of water per volume unit, varying for example in the case of rain or other precipitations.

The measurement of the quantity of water, its level, its flow rate as well as the volume and the concentration of the sediments in a continuous flow, is in general carried out by optical means which are expensive and not very suitable.

The invention proposes an apparatus suitable for carrying out a sampling at given time intervals or with respect to the variation in depth of water in the continuous flow, with a view to measuring the sought parameters in a simpler and less expensive manner on each sample, independently of other measurements which can be carried out simultaneously or separately by the same evaluation device.

To this end, the considered apparatus, comprising a fixed frame comprising a horizontal platform supporting a plurality of containers each designed to receive, via its open upper filling aperture, a determined water sample, these containers being distributed on this platform according to a circular arrangement around a central vertical shaft according to which a driving ring gear rotates parallel to the platform, this ring gear being mounted on a water supply pipe which extends perpendicularly to the platform and is connected at one end, by a revolving joint, to a pump for suction of the water from the continuous flow and the other end of which is joined to a horizontal dispensing arm, extending radially above the containers arranged on the support platform, this dispensing arm successively delivering a sample of water to each of these containers by its end opposite to the shaft, following the rotation of this arm under the effect of the driving ring gear, is characterized in that the horizontal supporting platform comprises, above the open apertures of the containers, a distribution disc, parallel to the platform and having an even number of dispensing openings, equal to twice that of the containers, half of these openings each being arranged opposite an open aperture of one of these containers and separated from each other by a similar intermediate discharge opening such that, between two samples collected in two successive containers, the water delivered by the dispensing arm is discharged via an intermediate opening, making it possible to carry out a flushing of this arm and of the supply pipe after filling of any container with a sample and before filling of the next container, following the rotation of the arm.

According to a complementary characteristic of the apparatus considered, the driving ring gear of the water supply pipe comprises a set of inclined peripheral gear teeth, in engagement with a worm gear, driven in continuous rotation by an asynchronous electric motor.

As a variant, the driving ring gear comprises a set of upright peripheral gear teeth, in engagement with a pinion.

According to another characteristic, each of the dispensing openings provided in the distribution disc comprises a short flexible tubing element, suitable for guiding the sample of water towards the open filling aperture of each container or to provide a discharge for the flushing out of the supply pipe and the dispensing arm, between the filling of two successive containers.

Advantageously, the containers are arranged on the horizontal support platform with a staggered distribution over the periphery of this platform, under the dispensing openings provided on the distribution disc.

In a preferred embodiment of the sample-taking apparatus according to the invention, the horizontal support platform comprises a raised outer edge, for the positioning and immobilization of the containers arranged beneath the distribution disc.

In the same embodiment, the support platform comprises a meshed or perforated surface on which the containers rest, in particular to allow the flow of the flushing water delivered by the dispensing arm between the fillings of two successive containers.

According to yet another characteristic, the fixed frame can be combined with a removable outer protective cover, removal thereof allowing free access to the distribution disc.

Other characteristics of an apparatus for the automatic taking of water samples from a continuous flow will also become apparent from the following description of an embodiment example, given as an indication and non-limitatively, with reference to the attached drawings in which:

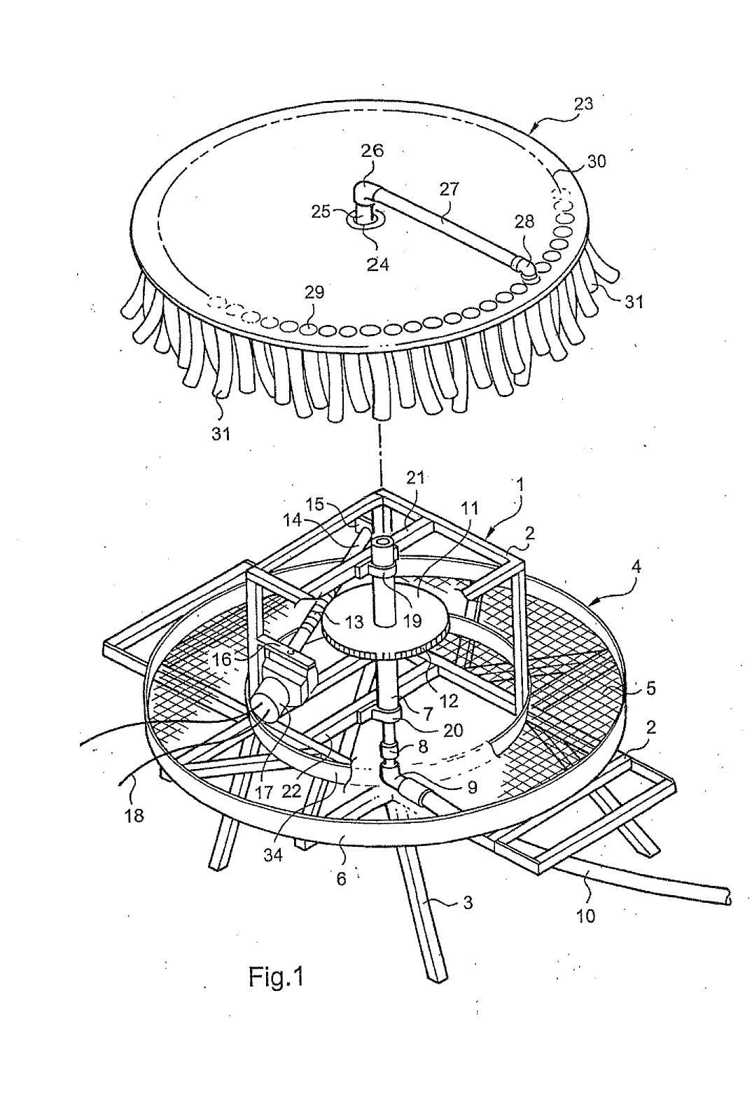

FIG. 1 is an exploded perspective view of the apparatus considered;

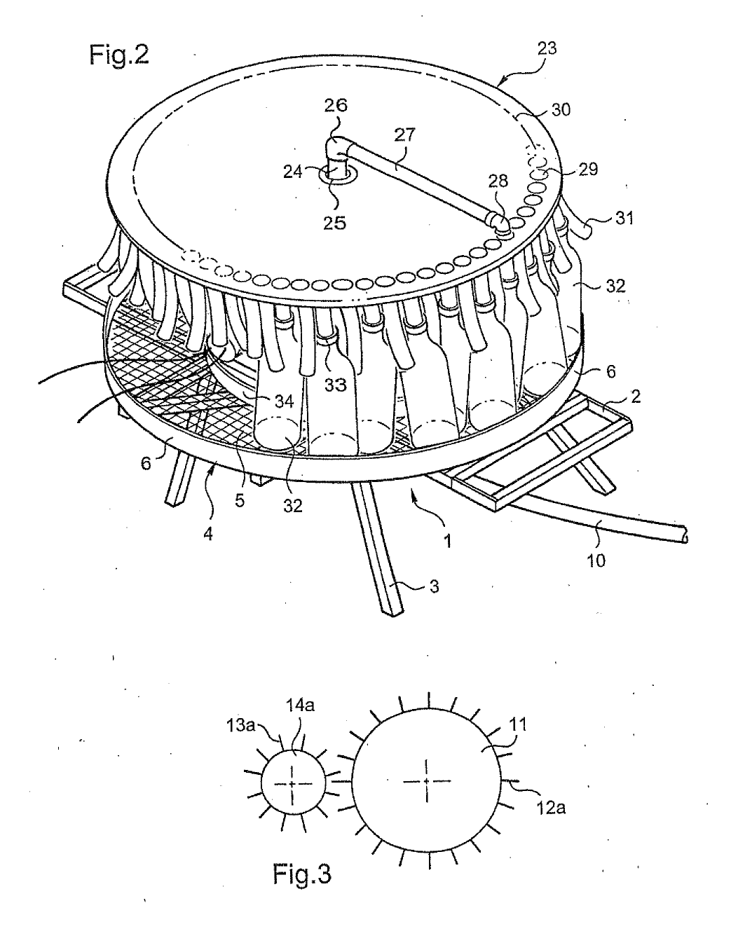

FIG. 2 is also a perspective view of the same device, but in which its various parts are shown assembled;

FIG. 3 is a diagrammatic view of a variant relating to a detail involved in the production of the device.

In FIGS. 1 and 2, reference 1 denotes the fixed frame of the considered sample-taking device, constituted by the assembly of metal profiles 2, suitably welded or otherwise connected to each other, this frame also comprising supporting legs 3 on the ground, making it possible to position the apparatus in any suitable place.

The legs 3 are joined to the frame 1 and preferably hinged to the latter, so that, once its legs have been folded up, the movement and transport of this frame from place to place can be facilitated, depending on the place where the taking of samples is to be performed.

The frame 1 also comprises a horizontal support platform 4, provided at its lower part, above the support legs 3, this platform having a meshed or coarsely perforated surface 5 for the reasons explained hereafter. The periphery of this platform is provided with an outer edge 6, which is circular and slightly raised in order to extend upwards from the meshed surface 5.

In the centre of the horizontal support platform 4, there is mounted, within the frame 1, a supply pipe 7 which extends vertically perpendicular to the plane of the platform and which is connected by a device 8 having a revolving joint, of the stuffing-box or similar type, to a coupling 9, ensuring the connection of this pipe to the end of a tubing 10, the other end of which is immersed in a continuous flow (not shown), situated nearby and from which the apparatus makes it possible to carry out the desired successive taking of samples.

In particular, the tubing 10 is provided with a standard suction pump (not shown) which makes it possible to carry out this sample-taking from the continuous flow, either at specific time intervals, preferably identical to each other, or with respect to the variation in the level of the water in the flow, in particular each time the depth of water increases by a specific value.

In its substantially median part, the vertical water-supply pipe 7 is solidly fixed to a ring gear 11, extending horizontally within the frame 1, parallel to the support platform 4, this ring gear comprising at its periphery a set of gear teeth 12 which, in the example illustrated in FIG. 1, are inclined so as to work together with the threaded part 13 of a worm 14, with which it engages.

Of course, such an arrangement is only indicative in character, it being possible to substitute the worm by a pinion 14a the teeth 13a of which work together with a corresponding set of gear teeth 12, this time upright, provided at the periphery of the driving ring gear 11, as shown diagrammatically in the detail view of FIG. 3.

The screw 14 rotates in support bearings 15 and 16 fixed on two profiles 2 of the frame 1 and is driven in continuous rotation by means of an asynchronous motor 17, the supply cables 18 of which are connected, at a suitable distance from the device, to an appropriate source of electrical power.

The supply pipe 7 thus turns within the frame 1 while being held axially in the latter by brackets 19 and 20, suitably welded to cross members, respectively 21 and 22, of the frame.

FIG. 1 shows in exploded view a distribution disc 23, extending horizontally, FIG. 2 showing the positioning of this disc on the frame 1 once the assembly of the various parts of the apparatus has been carried out.

The distribution disc 23 has a circular profile the diameter of which is substantially equal to that of the raised edge 6 of the support platform 4 and comprises a central opening 24 through which the upper end 25 of the supply pipe 7 passes slightly above the disc when the latter is put into place.

This end 25 of the pipe 7 is connected by a bend 26 to one end of a horizontal dispensing arm 27 which extends radially above the distribution disc 23, parallel to the latter, this arm comprising at its end opposite the pipe a fitting 28 through which the sampled water, delivered into the pipe 7 and beyond the latter into the arm 27 by the suction pump, can be delivered in order to flow through the disc 23 via any one of a plurality of dispensing openings 29.

These openings 29 are distributed around a circle 30 on the periphery of the disc 23 and are even in number, each of them being arranged at the same distance from the centre of the disc, so as to be able to be successively served by the fitting 28 at the end of the dispensing arm 27.

Each opening 29 is moreover associated with a short tubing element 31, which is connected to it in a watertight manner and extends a suitable distance under the surface of the distribution disc 23.

As shown in FIG. 2, the platform 4 mounted on the fixed frame 1, supports on its meshed surface 5 a set of containers 32, of the bottle type or other, preferably made of plastic, these containers 32 each comprising an upper filling aperture 33 the diameter of which is such that the end of a tubing element 31 carried by the disc 23 can engage freely therein, such that a sample of water taken from the flow and delivered by the dispensing arm 27 through the opening 29 of the disc associated with this element is collected in the container which receives the latter.

According to the invention, the number of containers 32 arranged on the meshed surface 5 of the support platform 4 is equal to half that of the openings 29 provided in the distribution disc 23, the openings associated with two successive containers being separated by a corresponding opening the tubing element 31 of which is free, the water delivered by this element, when the dispensing arm 27 is situated above this opening, spreading over the ground through the mesh of the meshed surface 5, outside the containers 32.

This arrangement has the advantage of allowing the flushing of the tubing 10, the supply pipe 7 and the dispensing arm 27 after each sample admitted to a container 32, before collection of the next sample in another container after the preceding one, situated on the support platform 4

Advantageously, the containers 32 thus distributed over the support platform 4 are arranged staggered in relation to each other while being held towards the outside of the platform by the raised edge 6 extending at the periphery of the latter. A similar edge 34, parallel to the edge 6, can also be provided on the platform, further within the frame 1 in order to hold the set of containers in position more effectively.

Preferably also, the apparatus can comprise a removable cover (not shown so as not to overcomplicate the drawing), this cover being arranged above the distribution disc 23 and the dispensing arm 27 and comprising a circular downward return surrounding externally all of the containers 32 placed on the support platform 4.

Thus a simple and inexpensive sample-taking apparatus is produced which is very robust and as a result suitable for use under climatic conditions which are sometimes difficult.

The containers containing the samples taken, collected from the dispensing arm, can then easily be collected one by one from the support platform with a view to carrying out the proposed measurements on the corresponding sample, using a separate apparatus which, apart from an evaluation of the parameters specific to the sample, such as in particular the quantity of sediments that it comprises or an estimation of its turbidity, is advantageously designed to supply other information concerning the velocity and flow rate of the continuous flow of origin of the samples or the depth of water therein at a given point in time.

Of course, it is self-evident that the invention is not limited to the embodiment example more particularly described above and represented in the attached drawings; on the contrary it includes all the variants thereof falling within the scope of the claims hereafter.

1-8. (canceled)

9. Apparatus for the automatic taking of samples of water from a continuous flow, comprising a fixed frame (1) comprising a horizontal platform (4) for the support of a plurality of containers (32) each designed to receive, by its upper open filling aperture (33), a determined sample of water, these containers being distributed according to a circular arrangement on this platform about a central vertical shaft along which pivots a driving ring gear (11) parallel to the platform, this ring gear being mounted on a water supply pipe (7) extending perpendicularly to the platform and connected at one end, through a rotating joint (8), to a pump for suction of the water from the continuous flow and the other end of which (25) is joined to a horizontal dispensing arm (21), extending radially above the containers arranged on the support platform, this dispensing arm successively delivering a water sample to each of these containers, by its end (28) opposite the shaft, following the rotation of this arm under the effect of the driving ring gear, characterized in that the supporting horizontal platform (4) comprises, above the open apertures of the containers, a distribution disc (23), parallel to the platform and having an even number of dispensing openings (29), equal to twice that of the containers (32), half of these openings each being arranged in front of an open aperture (33) of one of these containers and separated from each other by a similar intermediate discharge opening such that, between two samples collected in two successive containers, the water delivered by the dispensing arm (27) is discharged via an intermediate opening making it possible to carry out a flushing of this arm and of the supply pipe (7) after filling of any container with a sample and before filling of the next container, following the rotation of the arm.

10. The apparatus according to claim 9, characterized in that the driving ring gear (11) of the water supply pipe (7) comprises a set of inclined peripheral gear teeth (12), in engagement with a worm gear (13), driven in continuous rotation by an asynchronous electric motor.

11. The apparatus according to claim 9, characterized in that the driving ring gear (11) comprises a set of upright peripheral gear teeth (13a), in engagement with a pinion (14a).

12. The apparatus according to claim 9, characterized in that each of the dispensing openings (29) provided in the distribution disc (23) comprises a short flexible tubing element (31), designed to guide the sample of water towards the open filling aperture (33) of each container (32) or to ensure the discharge of the flushing of the supply pipe (7) and the dispensing arm (27), between the filling of two successive containers.

13. The apparatus according to claim 9, characterized in that the containers (32) are arranged on the horizontal support platform (4) with staggered distribution over the periphery of this platform, under the dispensing openings (29) on the distribution disc (23).

14. The apparatus according to claim 9, characterized in that the horizontal support platform (4) comprises a raised outer edge (6), for the positioning and immobilization of the containers arranged under the distribution disc (23).

15. The apparatus according to claim 9, characterized in that the support platform (4) comprises a meshed or perforated surface (5) on which the containers (32) rest, to allow the flow of the flushing water delivered by the dispensing arm (27) between the fillings of two successive containers.

16. The apparatus according to claim 9, characterized in that the fixed frame (1) is associated with a removable outer protective cover, removal thereof allowing free access to the distribution disc (23).

17. The apparatus according to claim 10, characterized in that each of the dispensing openings (29) provided in the distribution disc (23) comprises a short flexible tubing element (31), designed to guide the sample of water towards the open filling aperture (33) of each container (32) or to ensure the discharge of the flushing of the supply pipe (7) and the dispensing arm (27), between the filling of two successive containers.

18. The apparatus according to claim 10, characterized in that the containers (32) are arranged on the horizontal support platform (4) with staggered distribution over the periphery of this platform, under the dispensing openings (29) on the distribution disc (23).

19. The apparatus according to claim 10, characterized in that the horizontal support platform (4) comprises a raised outer edge (6), for the positioning and immobilization of the containers arranged under the distribution disc (23).

20. The apparatus according to claim 10, characterized in that the support platform (4) comprises a meshed or perforated surface (5) on which the containers (32) rest, to allow the flow of the flushing water delivered by the dispensing arm (27) between the fillings of two successive containers.

21. The apparatus according to claim 10, characterized in that the fixed frame (1) is associated with a removable outer protective cover, removal thereof allowing free access to the distribution disc (23).

22. The apparatus according to claim 11, characterized in that each of the dispensing openings (29) provided in the distribution disc (23) comprises a short flexible tubing element (31), designed to guide the sample of water towards the open filling aperture (33) of each container (32) or to ensure the discharge of the flushing of the supply pipe (7) and the dispensing arm (27), between the filling of two successive containers.
